(19) United States
(12) Patent Application Publication
(10) Pub. No.: US 2018/0330305 A1
(43) Pub. Date: Nov. 15, 2018

(54) DETERMINING A CANDIDATE TO RESPOND TO AN ISSUE

(71) Applicant: International Business Machines Corporation, Armonk, NY (US)

(72) Inventors: Christopher A. Hambridge, Raleigh, NC (US); Kevan D. Holdaway, Apex, NC (US); Wuchieh J. Jong, Raleigh, NC (US); Jorge L. Padilla, Raleigh, NC (US); Helen L. Gawor, Cary, NC (US)

(21) Appl. No.: 15/846,058

(22) Filed: Dec. 18, 2017

Related U.S. Application Data
(63) Continuation of application No. 15/590,220, filed on May 9, 2017.

(51) Int. Cl. G06Q 10/06; G06Q 30/02; G06Q 10/10

(52) U.S. Cl. CPC G06Q 10/063112; G06Q 10/06315; G06Q 10/06398; G06Q 10/10; G06Q 10/1097; G06Q 10/06; G06Q 10/105; G06Q 30/0205

(57) ABSTRACT

A pool of candidates to respond to an issue can be determined. For each of a plurality of candidates who are included in the pool of candidates, information corresponding to a respective candidate can be accessed. The information corresponding to the respective candidate can at least indicate the respective candidate's current location and metadata pertaining to the current location. For each of the plurality of candidates who are included in the pool of candidates, the information corresponding to the respective candidate can be analyzed. Based on the analyzing the information, at least one best available candidate to respond to the issue can be determined, the best available candidate selected from the pool of candidates.

### BACKGROUND

The present invention relates to data processing systems, and more specifically, to on-call management systems.

With the growth of Cloud based services, there is an increased need for immediate resolution of operational problems in order to maintain high availability of the services provided. Despite increased monitoring and operations automation, it's inevitable that some operational issues will require human intervention. A common enterprise procedure in handling such operational issues is to assign the issues to people for resolution based on predefined schedules.

### SUMMARY

A method includes determining a pool of candidates to respond to an issue. The method also can include accessing, for each of a plurality of candidates who are included in the pool of candidates, information corresponding to a respective candidate, the information corresponding to the respective candidate at least indicating the respective candidate's current location and metadata pertaining to the current location. The method also can include analyzing, using a processor, for each of the plurality of candidates who are included in the pool of candidates, the information corresponding to the respective candidate. The method also can include determining, based on the analyzing the information, at least one best available candidate to respond to the issue, the best available candidate selected from the pool of candidates.

### BRIEF DESCRIPTION OF THE DRAWINGS

FIG. 1 is a block diagram illustrating an example of a computing environment.

FIG. 2 illustrates an example of a framework for an on-call management application.

FIG. 3 is a block diagram illustrating example architecture for an on-call management system.

FIG. 4 is a flow chart illustrating an example of a method of determining at least one best available candidate to respond to an issue.

### DETAILED DESCRIPTION

This disclosure relates to data processing systems, and more specifically, to on-call management systems. In accordance with the inventive arrangements disclosed herein, a pool of candidates to respond to an issue can be determined. For each of the plurality of candidates who are included in the pool of candidates, information corresponding to the respective candidate can be accessed. The information corresponding to the respective candidate can at least indicate the respective candidate's current location and metadata pertaining to the current location. For each of the plurality of candidates who are included in the pool of candidates, the information corresponding to the respective candidate can be analyzed. Based on the analyzing the information, at least one best available candidate to respond to the issue can be determined, the best available candidate selected from the pool of candidates. Such processes can ensure that the issue is resolved in a very timely and effective manner.

The information corresponding to the respective candidate further can indicate a variety of other information. For example, the information for each candidate can indicate the candidate's skills (e.g., skill set), online activity, activity patterns, behavioral patterns, and so on. Such information also can be analyzed when selecting one or more candidates to respond to the issue. Thus, the candidate selection process can ensure that the candidates that are selected are not only available to immediately respond to the issue, but also that the candidates are well qualified to resolve the issue.

Further, engagement policies can be considered when selecting candidates, and the engagement policies can provide incentive for candidates to participate in resolving issues, even if the candidates are not on-call. For example, gamification strategies can be implemented to entice candidates to participate in resolving issues. A frequency selection limiter can be implemented to limit the frequency at which candidates are requested to participate in resolving issues. Accordingly, candidates are less likely to feel overburdened with resolving issues. Moreover, this provides other candidates opportunity to participate in issue resolution processes. Further, on-call periods for some candidates oftentimes exceed twenty-four hour periods, and can impact the personal schedules of candidates, such as sleep time, personal time, etc. The present arrangements minimize the impact on personal schedules due to requests to resolve various issues.

Several definitions that apply throughout this document now will be presented.

As defined herein, the term “candidate” means a person (i.e., a human being) who may be selected for a particular purpose.

As defined herein, the term “on-call” means to be available to work if necessary when not actually scheduled to be working.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “computer readable storage medium” means a storage medium that contains or stores program code for use by or in connection with an instruction execution system, apparatus, or device. As defined herein, a “computer readable storage medium” is not a transitory, propagating signal per se.

As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “client device” means a processing system including at least one processor and memory that requests shared services from a server, and with which a person directly interacts. Examples of a client device include, but are not limited to, a workstation, a desktop computer, a computer terminal, a mobile computer, a laptop computer, a netbook computer, a tablet computer, a smart phone, a personal digital assistant, a smart watch, smart glasses, a gaming device, a set-top box, a smart television and the like. Network infrastructure, such as routers, firewalls, switches, access points and the like, are not client devices as the term “client device” is defined herein.

As defined herein, the term “real time” means a level of processing responsiveness that a person or system senses as sufficiently immediate for a particular process or determination to be made, or that enables the processor to keep up with some external process.

As defined herein, the term “output” means storing in memory elements, writing to display or other peripheral output device, sending or transmitting to another system, exporting, or similar operations.

As defined herein, the term “automatically” means without user intervention.

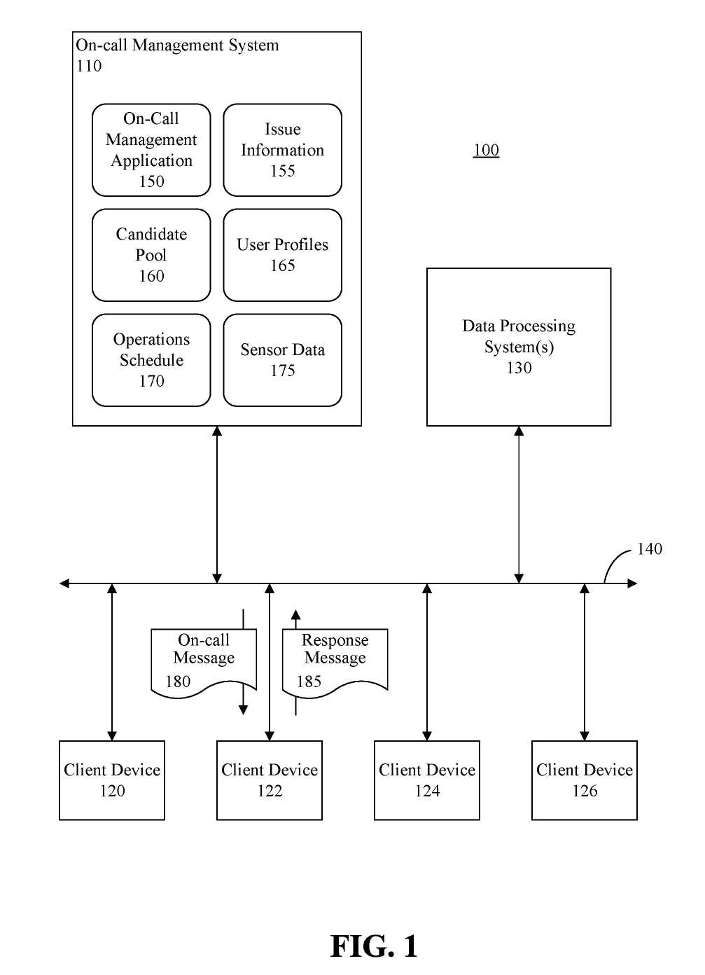

FIG. 1 is a block diagram illustrating an example of a computing environment 100. The computing environment can include an on-call management system 110 and a plurality of client devices 120, 122, 124, 126. Optionally, the computing environment 100 can include one or more other data processing systems 130.

The client devices 120-126 and data processing system(s) 130 can be communicatively linked to the on-call management system 110 via at least one network 140. A network 140 is the medium used to provide communications links between various devices and data processing systems connected together within the computing environment 100. The network 140 may include connections, such as wire, wireless communication links, or fiber optic cables. The network 140 can be implemented as, or include, any of a variety of different communication technologies such as a WAN, a LAN, a wireless network, a mobile network, a Virtual Private Network (VPN), the Internet, the Public Switched Telephone Network (PSTN), and/or similar technologies.

The on-call management system 110 can include at least one processor and memory, and can host an on-call management application 150 executed by the processor(s). The on-call management system 110 also can maintain and/or access a variety of information, including issue information 155, a candidate pool 160, user profiles 165, an operations schedule 170 and sensor data 175. For example, the issue information 155, candidate pool 160, user profiles 165, operations schedule 170 and sensor data 175 can be stored to a computer readable storage medium (e.g., memory elements) within the on-call management system 110 or stored to a computer readable storage medium to which the on-call management system 110 is communicatively linked. In one non-limiting arrangement, the issue information 155, candidate pool 160, user profiles 165, operations schedule 170 and sensor data 175 can be stored in one or more database tables or other suitable data structures. In a further arrangement, the sensor data 175 can be streamed to the on-call management system 110 by various sensors as the sensors generate the sensor data 175.

The issue information 155 can include information related to various issues that may arise, for instance issues that arise in one or more of the data processing systems 130, network infrastructure, client devices, physical structures (e.g., buildings, offices, etc.), and so on. The issues can be hardware problems, software problems, hardware/software problems, database problems, physical structure problems, etc. The issue information 155 for a particular issue can indicate a nature of the issue. For example, if the issue is a software problem, the issue information 155 can include one or more error codes generated due to the software problem. Further, the issue information 155 can indicate an application, module, component, etc. experiencing the issue, and log files related to such application, module, component, etc. The log files can be generated by the application, module, component, etc., by an operating system hosting the application, module, component, etc., or by another application. Similarly, if the issue is a hardware problem, the issue information 155 can include one or more error codes generated due to the hardware problem. Further, the issue information 155 can indicate the hardware and/or hardware component experiencing the issue, and log files related to such component. The log files can be generated by the hardware and/or hardware component, by other hardware communicatively linked to the hardware and/or hardware component, or by software executing on the hardware and/or hardware component.

The on-call management system 110 (e.g., the on-call management application 150) can receive issue information from one or more of the client devices 120-126, or more of the data processing system(s) 130, or directly from hardware and/or a hardware component experiencing an issue. For example, the data processing system 130 can automatically generate, in real time, issue information for a particular issue responsive to the data processing system 130 detecting the issue, and communicate the issue information to the on-call management application 150. Similarly, hardware and/or a hardware component can automatically generate, in real time, issue information for a particular issue responsive to the hardware and/or hardware component detecting the issue, and communicate the issue information to the on-call management application 150. In another example, a person can generate issue information for a particular issue using a client device 120-126, and initiate the client device 120-126 to communicate the issue information to the on-call management application 150. Responsive to receiving issue information for a particular issue, the on-call management application 150 can automatically assign, in real time, the issue to be a case, and assign a case identifier to the case. Further, the on-call management application 150 can store the issue information and case identifier for that case to a computer readable storage medium as issue information 155.

The candidate pool 160 can include a list of candidates (i.e., people) who are, or who may be, available to address various issues that may arise. In one arrangement, the candidate pool 160 can be limited to candidates scheduled to be on-call when issue information regarding a particular issue is received by the on-call management system 110. In another arrangement, the candidate pool 160 further can include other candidates who are not on-call, for example candidates who have updated their user profiles 165 to indicate that they may be contacted to resolve issues when not on-call. In this regard, engagement policies (e.g., gamification strategies) can be structured to encourage candidates to participate in resolution of issues, regardless of whether the candidates are on-call.

The user profiles 165 can include user profiles for each of the candidates in the candidate pool 160. Each user profile 165 can include a myriad of information pertaining to a respective candidate. For example, a user profile 165 can indicate contact information for a candidate (e.g., one or more electronic messaging addresses assigned to the candidate, one or more telephone numbers assigned to the candidate etc.), the candidate's home address, the candidate's work address and/or work location, the candidate's scheduled and/or normal working hours/days, hours/days in which the candidate is, or normally is, on-call, the candidate's skill sets and/or certifications, historical information related to how the candidate has responded to past on-call notifications (e.g., electronic messages and/or phone calls), working patterns of the candidate, activity patterns of the candidate inside and/or outside of work, previous patterns of behavior of the candidate, previous patterns of movement of the candidate, and so on. Various patterns of the candidate can be determined by capturing various data generated by one or more client devices 120-126 used by the candidate. For example, the client devices 120-126 can include an application that monitors such patterns and updates the candidate's user profile 165 based on such monitoring. In one non-limiting aspect of the present arrangements, each candidate can update his/her user profile 165 with contact information, work address and/or work location, scheduled and/or normal working hours/days, hours/days skill sets and/or certifications, working patterns, activity patterns, patterns of behavior, etc.

The user profiles 165 for each candidate also can include data indicating whether the candidate is scheduled to be on-call. If so, it can be assumed that the candidate is willing to participate in the resolution of issues, and the candidate can be included in the candidate pool 160. The user profiles 165 for each candidate further can include data indicating whether the candidate chooses to be notified of issues, and given an opportunity to participate in the resolution of issues, at times when the candidate is not scheduled to be on-call. If so, the candidate can be included in the candidate pool 160. In one non-limiting arrangement, the user profile 165 for each candidate can indicate the hours/days when the candidate is on-call. In another arrangement, the hours/days when the candidate is on-call can be indicated in the operations schedule 170. Further, the user profile 165 for each candidate can indicate the hours/days when the candidate is not on-call, but still chooses to be given an opportunity to participate in the resolution of issues.

In a further arrangement, regardless of whether the candidate is scheduled to be on-call, the user profile 165 for the candidate can indicate certain circumstances in which the candidate chooses not to participate in the resolution of issues. For example, the candidate can indicate in the candidate's user profile 165 that the candidate chooses not to participate in the resolution of issues when the candidate is in a religious facility (e.g., church, temple, mosque, etc.). In another example, the candidate can indicate in the candidate's user profile 165 that the candidate chooses not to participate in the resolution of issues when the candidate is attending an event, such as a conference, sporting event, etc.

The operations schedule 170 can include information indicating work schedules for persons who may be considered candidates in the candidate pool 160. Optionally, the operations schedule 170 can include on-call schedules for each of the persons, for example if the on-call schedules are not indicated in the user profiles 165. Optionally, the operations schedule 170 can include information indicating times when various hardware/software resources may be taken off-line for maintenance, trouble shooting, updates, and so on. The operations schedule 170 also can include information indicating times when various hardware/software resources are physically accessible, for example if hardware/software resources are physically located within a secured building and/or a secured area of a building.

The sensor data 175 can include sensor data generated by the client devices 120-126 and/or various other sensors (not shown). For example, a client device 120-126 can include a location sensor that indicates a current location of a candidate. An example of such a location sensor is a global positioning system (GPS) receiver. Another example of a location sensor is software executing in a client device 120-126. For example, if a candidate is logged into a client device 120-126 and/or interacting with a client device 120-126 assigned to a specific location, the software can generate sensor data indicating that the candidate is located at the specific location. The specific location can be determined based on, for example, a WiFi™ network to which the client device 120-126 is communicatively linked and/or a location beacon that detects a location of the client device 120-126. Such location information can be used to determine not only the candidate's specific location, but also to infer the candidate's activity in the location. For example, if the location information indicates the candidate is located in his/her office, it can be inferred that the candidate presently is working, and thus presently available. If the location information indicates the candidate is located in a break room, it can be inferred that the candidate presently is on break, and thus not presently available. If the location information indicates the candidate is located in a conference room, it can be inferred that the candidate presently is in a conference, and thus not presently available.

Thus, the sensor data 175 can indicate, for each candidate in the candidate pool 160, whether the candidate is at home, in the office, at a movie theater, in a restaurant, in a break room, in a conference room, in the candidate's office, etc. Further, the sensor data 175 can indicate online activity data of the candidate. For example, the client device 120-126 can generate sensor data indicating whether the candidate is presently accessing one or more resources via the Internet. The sensor data 175 also can include sensor data from one or more Internet of Things (IoT) sensors, for example, sensors that indicate whether the candidate is interacting with one or more Internet connected devices, which may include devices other than the client devices 120-126. Another example of sensor data 175 is data generated by a security system, such as a security gate at entrance to a parking lot or a secure entrance to a building.

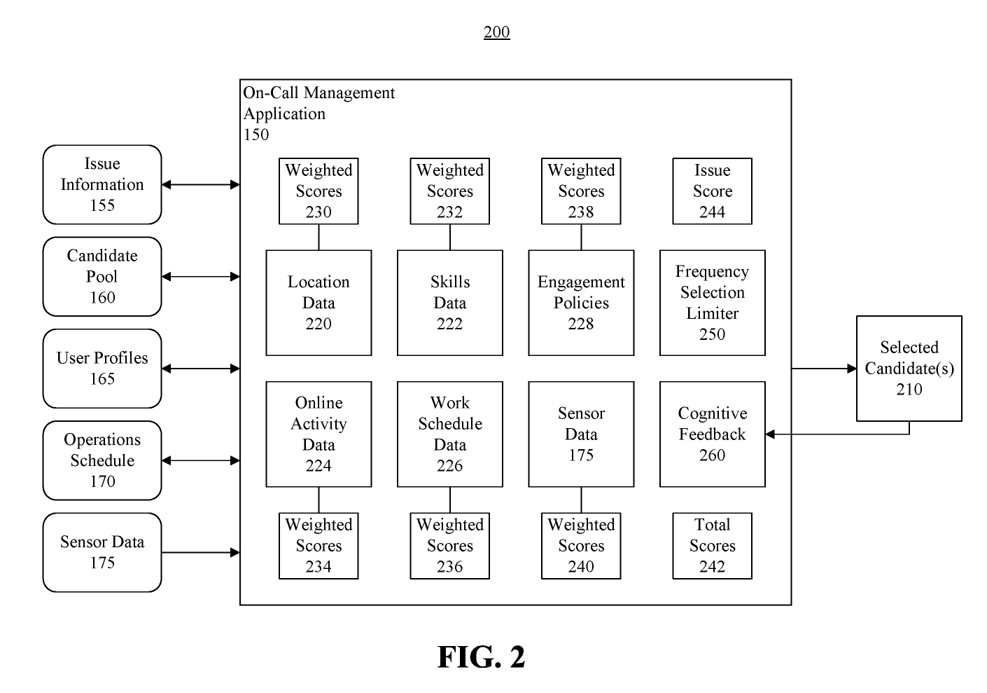

In operation, the on-call management application 150 can, responsive to receiving issue information for a particular issue and/or responsive to assigning the issue to be a case, select, in real time, at least one candidate from the candidate pool 160 to assign a task of resolving the issue. Selection of the at least one candidate is described in further detail with reference to FIG. 2 and can be based, at least in part, on the nature of the issue, the user profiles 165 of the candidates in the candidate pool 160, and various other information.

In one arrangement, responsive to selecting the candidate, the on-call management application 150 can contact the candidate with information regarding the task. For example, the on-call management application 150 can communicate, to the client device 122 used by the candidate, an on-call message 180 (i.e., an electronic message) requesting that the candidate accept a task of resolving the issue. The on-call message 180 can indicate the case identifier assigned to the issue, the nature of the issue, etc. Responsive to receiving the on-call message 180, the candidate can respond to the on-call message 180 by generating a response message 185 (i.e., an electronic message) indicating whether the candidate accepts or denies the task, and initiate the client device 122 to communicate the response message 185 to the on-call management application 150. In illustration, the on-call message 180 can include a menu item selectable by the user to accept the task and a menu item selectable by the user to deny the task. Responsive to the user selecting a menu item, the client device 122 can generate and communicate the response message 185, which can include data indicating the user's selection. In lieu of, or in addition to, menu items, one or more buttons or selectable icons can be presented to the user to select whether to accept or deny a task.

In another arrangement, responsive to selecting the candidate, the on-call management application 150 can automatically place a telephone call to the client device 122 used by the candidate, for example the candidate's mobile phone. The on-call management application 150 can place a telephone call to the candidate's home telephone or office telephone. In one aspect, the on-call management application 150 can call a first telephone number assigned to the candidate and, if there is no answer, can a second telephone number assigned to the candidate, and so on. Optionally, the on-call management application 150 can leave an automated voice message in the candidate's voice mail for one or more of the phones, for example using text-to-speech synthesis. If the user answers a phone, the on-call management application 150 can use text-to-speech synthesis to communicate to the user information relating to the task of resolving the issue. The on-call management application 150 can prompt the user to select a particular key (e.g., physical or virtual key), to accept the task and to select a particular key to deny the task.

If the candidate accepts the task, the on-call management application 150 can assign the candidate to the task, for example as a person assigned to the task. If the candidate denies the task, the on-call management application 150 can select another candidate from the candidate pool 160, and contact the other candidate with information regarding the task, as previously described. Further, the on-call management application 150 can update a user profile 165 of the candidate to indicate the task/issue, and indicate whether the candidate accepted or denied the task, or was not able to be contacted regarding the task. Such indication can be processed for various purposes, as will described.

FIG. 2 illustrates an example of a framework 200 for the on-call management application 150. As noted, the on-call management application 150 can receive issue information for a particular issue and store corresponding issue information 155. In response, the on-call management application 150 determine the candidate pool 160. As noted, the on-call management application 150 determine the candidate pool 160 to include candidates who are on-call, but also to include candidates who are not on-call, but choose to be available to respond to issues.

The on-call management application 150 can access the candidate pool 160, user profiles 165, operations schedules 170 and sensor data 175 and determine one or more selected candidates 210 from the candidate pool 160. To determine the selected candidates 210, the on-call management application 150 can process, in real time, various information gleaned from the issue information 155, user profiles 165, operations schedule 170 and sensor data 175.

In illustration, the on-call management application 150 can determine, for each candidate in the candidate pool 160, location data 220, skills data 222, online activity data 224 and work schedule data 226, and select one or more candidates 210 by processing such data. The location data for a particular candidate can be determined based on a current location of a client device 120-126 used by the candidate, from the sensor data 175, or in any other suitable manner. The skills data 222 for each candidate can be determined by processing the candidate's respective user profile 165. The skills data 222 can indicate, for each candidate in the candidate pool 160, particular areas of expertise of the candidate and/or certifications of the candidate in one or more particular areas of expertise. The online activity data 224, for each particular candidate, can be determined based on sensor data 175. The work schedule data 226, for each candidate, can be determined based on the user profile 135 for that candidate and/or the operations schedule 170.

In addition, to determine the selected candidates 210, the on-call management application 150 can process engagement policies 228. The engagement policies 228 can be structured to encourage candidate participation in resolving issues, monitor participation of candidates in resolving issues, and monitor success of candidates at resolving issues. In illustration, the engagement policies 228 can specify values (e.g., reward points) assigned to candidates who participate in resolving issues, specify values assigned to candidates who resolve issues, specify values assigned to candidates who accept tasks to resolve issues, and specify values assigned to candidates who decline tasks to resolve issues. The on-call management application 150 can compute the total values assigned to each candidate, for example as a sum or some other computational value, to arrive at a net value. The on-call management application 150 can process the net value for each candidate when evaluating the candidate to determine whether the candidate will be a selected candidate 210. Moreover, the engagement policies 228 can specify rewards to be provided to candidates based on the net value. In this regard, the engagement policies 228 can implement gamification strategies that encourage participation in resolving issues, and reward participation and/or performance in such participation.

When selecting the candidates 210, the on-call management application 150 can, for each candidate in the candidate pool 160, assign a weighted score 230, 232, 234, 236, 238, 240 to each of the location data 220, skills data 222, online activity data 224, work schedule data 226, engagement policies 228 and sensor data 175, respectively. Further, the on-call management can determine a total score 242 based on the weighted scores 230-240. For instance, the on-call management system can determine the total score 242 to be a sum of the weighted scores 230-240, though the present arrangements are not limited in this regard. The on-call management application 150 can rank the candidates based on the total score 242, and choose the candidate having the highest ranking (e.g., highest total score 242), or the candidates having the highest rankings, as the selected candidates 210. Based at least on the weighted scores 230, 234, 236, and optionally weighted scores 238, 240, the ranking for each candidate can represent an availability of the candidate to respond to the issue. Based on the weighted score 232, the ranking for each candidate also can represent the capability of the candidate to respond to the issue.

As noted, the location data 220 can be based, at least in part, on the sensor data 175. The on-call management application 150 can determine the weighted score 230 for the location data 220 based on the location where the respective candidate currently is located and metadata pertaining to the location. The on-call management application 150 can access the metadata from any of a number of sources. For example, assume a candidate currently is located on a roadway. The on-call management application 150 can access a mapping application (not shown), for example via the Internet, to access metadata pertaining to the location. The metadata can indicate that the location is a roadway, indicate a type of the roadway, indicate an identifier assigned to the roadway (e.g., Interstate 10), etc. In another example, assume the candidate is at home. The on-call management application 150 can access a mapping application to access metadata pertaining to the location, for example an address of the home. Further, the on-call management application 150 can compare the address to the candidate's home address indicated in the candidate's user profile 165, and determine that the candidate's current location is the candidate's home. If the candidate is at his/her place of work, the on-call management can access corresponding metadata in a similar manner. Mapping applications oftentimes include metadata indicating a description of certain locations, such as restaurants, movie theaters, shopping centers, parks, etc. Mapping application also oftentimes include metadata indicting roadway conditions (e.g., traffic conditions, weather conditions, etc.). The on-call management application 150 can access such metadata responsive to determining the candidate's current location is any such location.

In illustration, if a candidate currently is located in his/her work office, metadata assigned to that location can indicate that the location is his/her work office, and the on-call management application 150 can determine a high value for the weighted score 230, for example 10, based on the location and metadata. Further, based on the location being the candidate's office, the on-call management application 150 can infer a present activity to be working, and consider such activity when determining the weighted score 230. For example, the on-call management application 150 can generate a parameter that indicates “working,” assign a sub-score to such parameter, and evaluate the sub-score when determining the weighted score 230.

If a candidate currently is located in a restaurant, the on-call management application 150 can determine a different value for the weighted score 230, for example 4, based on that location and metadata pertaining to that location. Further, because the location is a restaurant, the on-call management application 150 can infer a present activity to be eating out, and consider such activity when determining the weighted score 230. If a candidate currently is located in a movie theater, the on-call management application 150 can determine a different value for the weighted score 230, for example 2, based on that location and metadata pertaining to that location. Because the location is a movie theater, the on-call management application 150 can infer a present activity to be watching a movie, and consider such activity when determining the weighted score 230.

The on-call management application 150 can determine the value for the weighted score 230 based on historical data. In illustration, the on-call management application 150 can determine how long the candidate has been present at the candidate's current location and, based on that determination and historical data, determine when the candidate will become available to respond to issues. For example, if the user profile 165 of the candidate indicates that the candidate usually takes one hour for lunch, the candidate is at a restaurant during lunchtime, and the candidate has been in the restaurant for forty-five minutes, the on-call management application 150 can infer that the candidate soon will be heading back to the office and be available in the office within the next fifteen minutes.

If a candidate currently is at a location and/or attending an event for which the candidate's user profile 165 indicates that the candidate chooses not to participate in the resolution of issues when the candidate is in the location and/or attending the event, the on-call management application 150 can determine a different value for the weighted score 230, for example 0, based on that location/event and metadata pertaining to that location/event. For instance, if the user is in a religious facility or attending an event (e.g., conference, sporting event, etc.), the on-call management application 150 can determine a value for the weighted score 230 to be 0.

If a candidate currently is located in his/her home, the on-call management application 150 can determine a different value for the weighted score 230, for example 8, based on that location and metadata pertaining to that location. In one aspect, the candidate's user profile 165 can indicate previous patterns of behavior of the user while at home. For example, the user profile 165 can indicate times when the candidate is eating, sleeping, browsing the Internet, etc. Such patterns of behavior also can be considered when determining the weighted score 230. For example, if the candidate's behavior indicates the candidate currently is sleeping, the value assigned to the weighted score 230 can be lower in comparison to if the candidate's behavior indicates the candidate is awake. Further, the on-call management application 150 can determine a time zone in which the candidate currently is located, determine the current time in that time zone, and correlate the candidate's behavior to the current time in that time zone.

If a candidate currently traveling, the on-call management application 150 can determine such circumstance based on whether the candidate currently is on a roadway, for example based on location data 220 (e.g., GPS data). Further, the on-call management application 150 can determine, based on the location data 220, a speed and direction of travel of the candidate on the roadway. The on-call management application 150 can access metadata pertaining to the roadway to identify traffic conditions on the roadway. Based on the current time, roadway, direction of travel, traffic conditions, weather conditions, and previous patterns of movement of the candidate indicated in the candidate's user profile 165, the on-call management application 150 can determine where the candidate is traveling and when the candidate is anticipated to arrive at a destination. The on-call management application 150 can determine the value to assign to the weighted score 230 based, at least in part, on such information. For example, if the information indicates the candidate is traveling toward work and will arrive at work within a first threshold period of time, for instance within the next thirty minutes, the on-call management application 150 can assign a higher value to the weighted score 230 than if the candidate will arrive at work in sixty minutes. If the information indicates the candidate is traveling to an event, for example a recreational event, the on-call management application 150 can assign a lower score to the weighted score 230 since the candidate may not wish to be interrupted during the event. In this regard, the on-call management application 150 can infer an activity of the user to be recreation based on previous patterns of behavior of the candidate. Still, the on-call management application 150 can determine the weighted score 230 based on any of a myriad of location related scenarios, and the present arrangements are not limited in this regard.

The on-call management application 150 can determine the weighted score 232 for the skills data 222 based on the skills of the respective candidate, and how closely the skills match a skill set anticipated to be required to resolve the issue. For example, if the issue is a problem with a PHP query being used to access a database, and the candidate's skills data 222 indicates the candidate is an expert in PHP, the on-call management application 150 can determine a high value for the weighted score 232, for example 10. If the candidate's skills data 222 does not indicate that the candidate is an expert in PHP, but indicates that the candidate manages databases, the on-call management application 150 can determine a different value for the weighted score 232, for example 7. If, however, the candidate's skills data 222 does not list expertise or experience with databases or PHP, but indicates the candidate has experience in hardware configuration, the on-call management application 150 can determine a different value for the weighted score 232, for example 1. Again, the on-call management application 150 can determine the weighted score 232 based on any of a myriad of skills data 222 and issues, and the present arrangements are not limited in this regard.

The on-call management application 150 can determine the weighted score 234 for the online activity data 224 based on the online activity of the respective candidate. For example, if the candidate is online using the candidate's work computer, the on-call management application 150 can determine a high value for the weighted score 234, for example 10. If the candidate is online using the candidate's home computer, the on-call management application 150 can determine a different value for the weighted score 234, for example 7. If the candidate is online using a mobile device (e.g., mobile phone), the on-call management application 150 can determine a different value for the weighted score 234, for example 4. If the candidate is not online, the on-call management application 150 can determine a different value for the weighted score 234, for example 0. The on-call management application 150 can determine the weighted score 234 based on any type of online activity data 224, and the present arrangements are not limited in this regard.

The on-call management application 150 can determine the weighted score 236 for the work schedule data 226 based on the work schedule of the respective candidate. For example, if the candidate's work schedule data 226 indicates the candidate currently is scheduled to be at work, the on-call management application 150 can determine a high value for the weighted score 236, for example 10. If the candidate's work schedule data 226 indicates the candidate is scheduled to be at work within a first threshold period of time, for instance within the next thirty minutes, the on-call management application 150 can determine a different value for the weighted score 236, for example 7. If the candidate's work schedule data indicates the candidate is scheduled to be at work within a second threshold period of time, for instance within the next sixty minutes, the on-call management application 150 can determine a different value for the weighted score 236, for example 5. If the candidate's work schedule data indicates the candidate is on-call, the on-call management application 150 can determine a different value for the weighted score 236, for example 8. If the candidate's work schedule data indicates the candidate is not on-call, and not scheduled to work on the current day, the on-call management application 150 can determine a different value for the weighted score 236, for example 2. If the candidate's work schedule data indicates the candidate is not on-call, and is scheduled to be on vacation, the on-call management application 150 can determine a different value for the weighted score 236, for example 0. The on-call management application 150 can determine the weighted score 236 based on any type of work schedule data 226, and the present arrangements are not limited in this regard.

The on-call management application 150 can determine the weighted score 238 for the engagement policies 228 based on the level of engagement of the respective candidate in resolving issues. The weighted score 238 can be determined based on a myriad of factors. Such factors can include, for example, whether the candidate has indicated that he/she is willing to help resolving issues even when not on call, past participation by the candidate in resolving issues, a record of success of the candidate in resolving issues, and so on. In illustration, if the candidate has indicated that he/she is willing to help resolving issues even when not on call, has participated in resolving issues at least a first threshold number of times, and has been successful at resolving such issues at least a first threshold percentage of the times, the on-call management application 150 can determine a high value for the weighted score 238, for example 10. If the candidate has not indicated that he/she is willing to help resolving issues even when not on call, has not participated in resolving issues at least a second threshold number of times, and has not been successful at resolving such issues at least a second threshold percentage of the times, the on-call management application 150 can determine a low value for the weighted score 238, for example 1. Nonetheless, the on-call management application 150 can determine the weighted score 238 based on any level of engagement/success pertaining to resolving issues, and the present arrangements are not limited in this regard.

The on-call management application 150 can determine the weighted score 240 for the sensor data 175 based on evaluating the sensor data 175. In illustration, if the sensor data 175 indicates the candidate is at work, for example based on a scan of the candidate's key card, the on-call management application 150 can determine a high value for the weighted score 240, for example 10. If the sensor data 175 indicates the candidate has entered a parking lot at the candidate's work location, for example based on a scan of a key card or other sensor data indicating the candidate entered the parking lot, but the candidate's key card has not yet been scanned at an entry of the building where the candidate works, the on-call management application 150 can determine a different for the weighted score 240, for example 7. In another aspect of the present arrangements, the weighted score 240 need not be assigned to the sensor data 175. Instead, the sensor data 175 can be captured in the location data 220 and/or online activity data 224.

In one arrangement, the on-call management application 150 can include a frequency selection limiter 250. The on-call management application 150 can use the frequency selection limiter 250 to limit a frequency at which candidates are chosen as selected candidates 210. In illustration, it can be cumbersome for certain candidates to be selected too frequently. The frequency selection limiter 250 can be used to balance the response workloads across the candidate pool 160, for example based on a frequency at which the candidate has been requested to respond to previous issues and/or a last time the candidate was requested to respond to a previous issue.

In illustration, assume that a candidate assigned the highest total score 242, but that candidate has already been selected to resolve a threshold number of issues in the current week, or that candidate has been selected a number of times that exceeds, by a threshold value, an average number of times that candidates have been selected. In such case, the frequency selection limiter 250 can generate a parameter indicating that a frequency at which the candidate has been requested to respond to other issues exceeds a threshold value. The parameter can indicate to the on-call management application 150 to disregard that candidate when choosing the selected candidate(s) 210.

In another example, the frequency selection limiter 250 can determine when the respective candidate was last notified to respond to another issue. If a duration of time between the current time and the time when the candidate was last notified to respond to another issue is less than a threshold value, the frequency selection limiter 250 can generate a parameter indicating that the duration of time between the current time and the time when the candidate was last notified to respond to another issue is less than the threshold value. Such parameter can indicate to the on-call management application 150 to disregard that candidate when choosing the selected candidate(s) 210.

As noted, one or more candidates can be chosen as the selected candidate(s) 210. The on-call management application 150 can select the number of candidates to be chosen based on the nature and/or importance of the issue. For example, the on-call management application 150 can assign an issue score 244 to each issue based on the nature and/or importance of the issue. In illustration, if the issue only adversely affects a number of tuples being processed by a streaming application that is below a first threshold percentage, but the streaming application is still meeting requirements specified in a service level agreement (SLA), the on-call management application 150 can assign a low issue score 244. Based on the issue score 244 being low, the on-call management application 150 can choose a single candidate to be the selected candidate 210. On the other hand, if the issue adversely affects a number of tuples being processed by a streaming application that is above a second threshold percentage and, due to the issue, the streaming application is not meeting requirements specified in the SLA, the on-call management application 150 can assign a high issue score 244. Based on the high issue score 244, the on-call management application 150 can choose a plurality of candidates as selected candidates 210. Further, the on-call management application 150 can determine the issue score 244 based on a complexity of the issue. For example, the issue score 244 can be relatively low if the issue is clearly identified as being caused by a single hardware/software component, but relatively higher if the issue is not clearly identified as being caused by a single hardware/software component, and even higher if the hardware/software component(s) causing the issue is/are not identified.

The selected candidate(s) 210 can provide cognitive feedback 260 to the on-call management application 150, for example subsequent to resolving the issue or attempting to resolve the issue, or subsequent to a candidate accepting or denying a request to accept a task of resolving the issue. The on-call management application 150 can process the cognitive feedback 260 and, based on such processing, update a variety of data and analysis processes. This can improve a quality of analysis processes implemented by the on-call management application 150 to determine best available candidates to respond to future issues.

For example, based on the cognitive feedback 260, the on-call management application 150 can update the user profile 165 of the candidate providing the cognitive feedback, update the operations schedule 170, update the issue information 155, etc. For instance, the on-call management application 150 may have improperly determined the candidate as being available based on the location data 220, when in fact they the candidate may have been indisposed. Based on such cognitive feedback 260, the on-call management application 150 can update the user profile 165 of the candidate to reflect that the user is unavailable when in that location. This can be used by the on-call management application 150 when determining the weighted score 230 for future issues.

In another example, a candidate's skill may have been incorrectly interpreted by the on-call management application 150 as being applicable to the particular issue (e.g., the weighted score 232 determined for the candidate was too high). Based on such cognitive feedback 260, the on-call management application 150 can update the user profile 165 of the candidate to indicate the user's skill set is not well suited for that type of issue. This can be used by the on-call management application 150 when determining the weighted score 232 for future issues. In another example, cognitive feedback 260 can be provided by candidates in the candidate pool 160 who were not selected. For example, a candidate can suggest that he/she should be selected for a similar issue in the future.

Further, based on the cognitive feedback 260, the on-call management application 150 can update one or more processes used for determining the weighted scores 230-240, the total score 242 and/or the issue score 244. Such updates can improve the quality and/or accuracy of analyzing various data/information to generate the scores 230-244 for future issues. Also, based on the cognitive feedback 260, the on-call management application 150 can update the frequency selection limiter 250, for example to assign and/or update a particular threshold value used in determining whether the candidate is disregarded when candidate selection is being performed.

To process the cognitive feedback 260, the on-call management application 150 can implement natural language processing (NLP) and semantic analysis on information contained in the cognitive feedback 260. NLP is a field of computer science, artificial intelligence and linguistics which implements computer processes to facilitate interactions between computer systems and human (natural) languages. NLP enables computers to derive computer-understandable meaning from natural language input. The International Organization for Standardization (ISO) (e.g., ISO/TC37/SC4) publishes standards for NLP. Semantic analysis is the implementation of computer processes to generate computer-understandable representations of natural language expressions. Semantic analysis can be used to construct meaning representations, semantic underspecification, anaphora resolution, presupposition projection and quantifier scope resolution, which are known in the art. Semantic analysis is frequently used with NLP to derive computer-understandable meaning from natural language input. An unstructured information management architecture (UIMA), which is an industry standard for content analytics, may be used by the on-call management application 150 to implement NLP and semantic analysis.

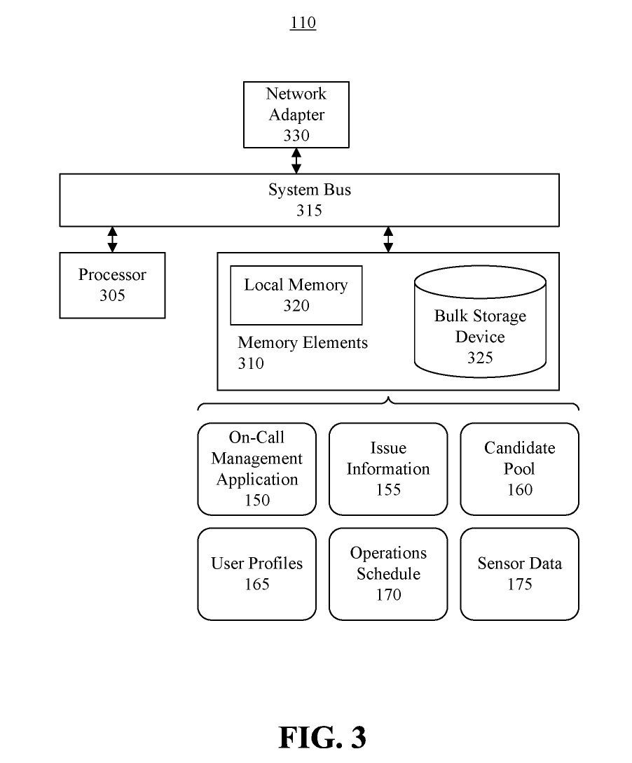

FIG. 3 is a block diagram illustrating example architecture for the on-call management system 110 of FIG. 1. The on-call management system 110 can include at least one processor 305 (e.g., a central processing unit) coupled to memory elements 310 through a system bus 315 or other suitable circuitry. As such, the on-call management system 110 can store program code within the memory elements 310. The processor 305 can execute the program code accessed from the memory elements 310 via the system bus 315. It should be appreciated that the on-call management system 110 can be implemented in the form of any system including a processor and memory that is capable of performing the functions and/or operations described within this specification. For example, the on-call management system 110 can be implemented as a server, a plurality of communicatively linked servers, a workstation, a desktop computer, a mobile computer, a tablet computer, a laptop computer, a netbook computer, a smart phone, a personal digital assistant, a set-top box, a gaming device, a network appliance, and so on.

The memory elements 310 can include one or more physical memory devices such as, for example, local memory 320 and one or more bulk storage devices 325. Local memory 320 refers to random access memory (RAM) or other non-persistent memory device(s) generally used during actual execution of the program code. The bulk storage device(s) 325 can be implemented as a hard disk drive (HDD), solid state drive (SSD), or other persistent data storage device. The on-call management system 110 also can include one or more cache memories (not shown) that provide temporary storage of at least some program code in order to reduce the number of times program code must be retrieved from the bulk storage device 325 during execution.

One or more network adapters 330 can be coupled to the on-call management system 110 to enable the on-call management system 110 to become coupled to other systems, computer systems, remote printers, and/or remote storage devices through intervening private or public networks. Modems, cable modems, transceivers, and Ethernet cards are examples of different types of network adapters 330 that can be used with the on-call management system 110.

As pictured in FIG. 3, the memory elements 310 can store the components of the on-call management system 110, namely the on-call management application 150, issue information 155, candidate pool 160, user profiles 165, operations schedule 170 and sensor data 175. Being implemented in the form of executable program code, these components of the or on-call management system 110 can be executed by the on-call management system 110 and, as such, can be considered part of the on-call management system 110. Moreover, the on-call management application 150, issue information 155, candidate pool 160, user profiles 165, operations schedule 170 and sensor data 175 are functional data structures that impart functionality when employed as part of the on-call management system 110.

Results generated by the on-call management system 110 can be output to, and stored within, the memory elements 310. As used herein, “outputting” and/or “output” can mean storing in the memory elements 310, for example, writing to a file stored in the memory elements 310, writing to the display or other peripheral output device, playing audible notifications, sending or transmitting to another system, exporting, or similar operations.

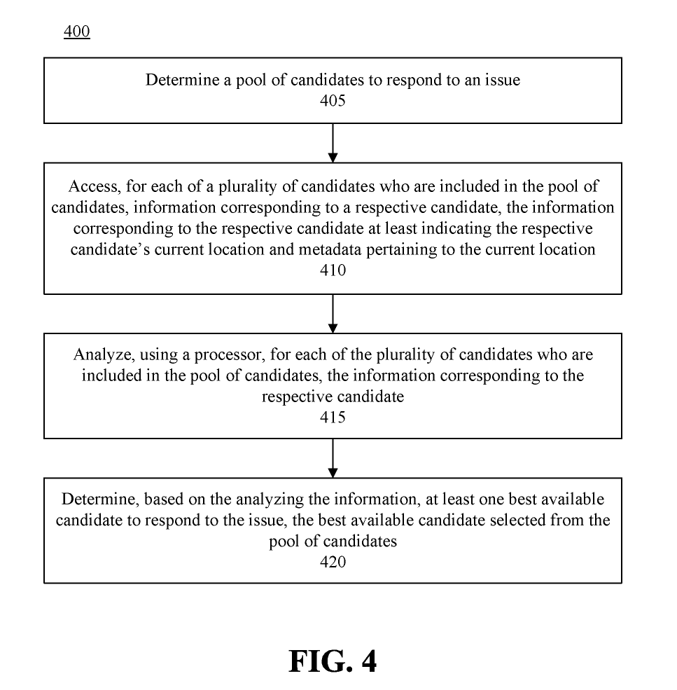

FIG. 4 is a flow chart illustrating an example of a method 400 of determining at least one best available candidate to respond to an issue. At step 405, the on-call management system 110 can determine a pool of candidates to respond to an issue. At step 410, the on-call management system 110 can access, for each of a plurality of candidates who are included in the pool of candidates, information corresponding to a respective candidate, the information corresponding to the respective candidate at least indicating the respective candidate's current location and metadata pertaining to the current location. At step 415, the on-call management system 110 can analyze, using a processor, for each of the plurality of candidates who are included in the pool of candidates, the information corresponding to the respective candidate. At step 420, the on-call management system 110 can determine, based on the analyzing the information, at least one best available candidate to respond to the issue, the best available candidate selected from the pool of candidates.

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” or similar language means that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method comprising:
determining a pool of candidates to respond to an issue;
accessing, for each of a plurality of candidates who are included in the pool of candidates, information corresponding to a respective candidate, the information corresponding to the respective candidate at least indicating the respective candidate's current location and metadata pertaining to the respective candidate's current location; and
analyzing, using a processor, for each of the plurality of candidates who are included in the pool of candidates, the information corresponding to the respective candidate; and
determining, based on the analyzing the information, at least one best available candidate to respond to the issue, the best available candidate selected from the pool of candidates.

2. The method of claim 1, wherein:
each respective candidate is ranked according to availability of the respective candidate to respond to the issue.

3. The method of claim 1, wherein:
the best available candidate to respond to the issue is determined based, at least in part, on an activity of the respective candidate at the respective candidate's current location.

4. The method of claim 3, wherein:
the information corresponding to the respective candidate further indicates previous patterns of behavior of the respective candidate; and
the activity of the respective candidate at the respective candidate's current location is predicted based on the respective candidate's current location and the previous patterns of behavior of the respective candidate.

5. The method of claim 1, wherein:
the information corresponding to the respective candidate further indicates previous patterns of movement of the respective candidate; and
the best available candidate to respond to the issue is determined based, at least in part, on the previous patterns of movement of the respective candidate.

6. The method of claim 1, wherein:
the information corresponding to the respective candidate further indicates at least one parameter selected from a group of parameters including a parameter indicating the respective candidate's skill set, a parameter indicating work schedule of the respective candidate, and a parameter indicating online activity of the respective candidate.

7. The method of claim 1, wherein:
the information corresponding to the respective candidate further indicates at least one parameter selected from a group of parameters including a parameter indicating that a frequency at which the candidate has been notified to respond to other issues exceeds a threshold value, and a parameter indicating that a duration of time between a current time and a time when the candidate was last notified to respond to another issue is less than a threshold value.

8. The method of claim 1, further comprising:
receiving feedback from the at least one best available candidate; and
responsive to receiving the feedback, improving a quality of analysis processes used to determine best available candidates to respond to future issues based on processing the feedback.

9-20. (canceled)
